(19) United States
(12) Patent Application Publication
(10) Pub. No.: US 2009/0056293 A1
(43) Pub. Date: Mar. 5, 2009

(54) AIR FILTRATION SYSTEM

(75) Inventor: Martin James Styles, Essex (GB)

Correspondence Address: FRASER CLEMENS MARTIN & MILLER LLC, 28366 KENSINGTON LANE, PERRYSBURG, OH, 43551, US

(73) Assignee: Visteon Global Technologies, Inc., Van Buren Township, MI (US)

(21) Appl. No.: 12/198,993

(22) Filed: Aug. 27, 2008

(30) Foreign Application Priority Data
Sep. 5, 2007 (GB) 0717313.1

(51) Int. Cl. B01D 50/00; B01D 46/52

(52) U.S. Cl. 55/385.3; 55/497

(57) ABSTRACT

An air filter is disclosed including a particulate filtration portion for filtering particulates from inlet air flow. The filtration portion is produced from a first sheet of air filtration material folded into a pleated volume that is bounded by a plurality of sides including a pair of opposite folded sides, through which air flow passes, at least one pleated side that extends between the folded sides, and at least one end side at each end of the series of pleats. The pleated sides and end sides meet along at least one corner edge of the pleated volume, and the pleated side meets each of the folded sides along side edges that extend along the series of pleats. The air filter also has a side sealing portion for forming a particulate seal within the housing along the pleated side. The sealing portion is made from a second sheet of air filtration material that covers the pleated side and projects beyond the pleated side to provide a flange that extends upright from a folded side along a corresponding side edge.

### CROSS-REFERENCE TO RELATED APPLICATION

This application claims priority to United Kingdom Patent Application No. 0717313.1, filed Sep. 5, 2007, the entire disclosure of which is hereby incorporated herein by reference.

### FIELD OF THE INVENTION

The present invention relates to the filtration of inlet air for an internal combustion engine.

### BACKGROUND

There are many types of air filtration systems for internal combustion engines. Generally, such systems include a housing which can be opened to reveal within a replaceable air filter. The housing is divided internally by the air filter into an upstream portion and a downstream portion which are connected respectively to an air inlet and an air outlet. A seal is provided around the air filter to separate the upstream and downstream portions within the housing.

If the seal is not complete, then unfiltered air can bypass the seal, in which case particulates can be drawn into the engine. This will increase engine wear and reduce the ultimate engine lifetime. Ideally the seal should be at least 99% efficient.

The air filter is formed from a body having an extended surface area normally made from a pleated paper or non-woven fabric material, which can have a rectangular or quadrilateral outline. The filter also includes a seal which extends around the filter where this joins the interior of the housing.

Some engine air filters have a seal made from a compliant plastic or rubber material which is either injection moulded or, alternatively, cast and set around external surfaces of the filtration material. This moulded or cast seal then engages with a matching seat in the filter housing.

Another type of air filter has a rigid or semi-rigid plastic frame or rim which is moulded around the periphery of the air filtration material. The rim has a rubber seal which then engages with a matching seat in the filter housing.

All such separate seals can be highly efficient, but the seal needs to be formed in a separate production process from that in which the pleated air filter is created. Furthermore, whereas the air filtration material can be formed and pleated in a continuous or near continuous process, the formation of a moulded or cast seal around the edge of the filtration material can take significantly longer and so is a rate determining step in the manufacturing process.

U.S. Pat. Appl. Pub. No. US 2006/0090433 A1 therefore proposes an air filtration system for an internal combustion engine having an air filter formed from a rectangular outline filtration material which does not have a separate moulded or cast peripheral seal. The filter has a series of zigzag pleats which extend along one longitudinal direction and which are glued to and bounded to a pair of opposite side walls formed from the same filtration material used in the pleats. Instead of a separate moulded or cast seal, portions of the side walls are bent to extend laterally away from the pleats to be gripped between upper and lower flanges along a seam between upper and lower halves of an air filter housing.

A seal is made along the other two sides of the rectangular outline air filter by a pair of parallel and oppositely directed inserts, one on each of the filter housing halves, which are offset in the longitudinal direction by a distance equal to half the distance for one cycle of pleats. These inserts project into opposite sides of the pleats, so that pleated filtration material is compressed between the inserts to form a seal along each of these sides.

Whilst this arrangement is quite effective at forming a good seal along the opposite sides where pleated material is compressed between the oppositely directed inserts, in use, it has been observed that any imperfection in the grip of the filtration material between the flanges will provide a short path for external dirty air to leak into the clean side of the air filter. Further problems can arise at the juncture between the seals where the sides of the air filter meet, as it is difficult to ensure that the adjacent seals meet without a break at the corners of the air filter and surrounding housing.

It would be desirable to produce a filter housing which addresses these issues.

### SUMMARY OF THE INVENTION

According to a first aspect of the invention, there is provided air filtration system for an internal combustion engine, the air filtration system comprising an air filter and an air filter housing, the air filter being removably held within the housing, the housing having an air inlet for providing an unfiltered inlet air flow to the air filter and an air outlet for receiving a filtered outlet air flow from the air filter, wherein the air filter has:
a particulate filtration portion for filtering particulates from said inlet air flow, said filtration portion being made from a first sheet of air filtration material folded into a pleated volume, said pleated volume being bounded by a plurality of sides including a pair of opposite folded sides through which said air flow passes, at least one pleated side that extends between said folded sides and at least one end side at an end of said series of pleats, said pleated and end sides meeting along at least one corner edge of said pleated volume and said pleated side meeting each of the folded sides along side edges that extend along said series of pleats;
a side sealing portion for providing a particulate seal within the housing along said pleated side, said sealing portion being made from a second sheet of air filtration material, said sheet covering said pleated side and projecting beyond said pleated side to provide a first flange that extends upright from a folded side along a corresponding side edge;
and wherein the housing has:
a first sealing means that engages said flange along the length of a corresponding side edge to provide a first particulate seal between the housing and the air filter;
a second sealing means that engages with at least one end pleat along a corresponding end side to provide a second particulate seal between the housing and the air filter;
a third sealing means that engages said second sheet of air filtration material along said corner edge to provide a third particulate seal between the housing and the air filter, said third particulate seal extending between said first and second particulate seals.

The end pleat may be an endmost pleat or a pleat proximate the endmost pleat.

The folded sides of the air filter have a quadrilateral outline. In an embodiment of the invention, this outline is a rectangular outline, with the filter having a long axis in the direction of the pleats and a short axis in a direction along the pleat fold lines. The air filter then has a pair of opposite pleated sides between which extends a pair of folded sides. One of the folded sides receives a flow of unfiltered air which passes through the pleated volume to exit from the other of the folded sides. A pair of upright flanges then extends from a common folded side where this meets the adjacent pleated sides. The flanges may then be substantially parallel with each other, and also with the long axis of the air filter.

Similarly, there is a pair of opposite end sides, at each end of the series of pleats, in which case there may be four similar corner edges. Each of the pair of side sealing portions, including the flanges then may extend in the direction of the series of pleats fully towards a pair of opposite corner edges.

The side sealing portion may be substantially planar across the extent of both the side sealing portion in contact with the pleated side and also the projecting flange.

The air filter is typically formed substantially entirely of a resiliently compressible filtration material, which may be a non-woven filter material. In another embodiment of the invention, the side sealing portion is bonded to the particulate filtration portion by means of an adhesive. To form a complete seal, the adhesive follows the zigzag contact line between the exposed edges of pleats of the pleated side of the air filtration material and a substantially planar sheet forming the side sealing portion.

The air filter will, in general, be removably seated within the housing. The housing may then form a particulate seal with by means of contact with and/or compression of the filtration material air filter.

The first sealing means may include a groove in an inside surface of the housing which receives and engages with opposite sides of the flange. The groove may then extend the full length of the filtration material generally parallel with the adjacent side edge from which the flange extends upright.

In another embodiment of the invention, the second sheet of air filtration material has a first face which faces outwards from the air filter and a second face which faces in towards the particulate filtration portion. The third sealing means may then be arranged to engage with at least a portion of both of these faces to provide the third particulate seal.

Also in an embodiment, the third sealing means is provided by an interaction between the first and second sealing means in the vicinity of the corner edge. As the second sheet of air filtration material may be compressible, with this interaction may involve the compression of the air filtration material along a line substantially parallel with the corner edge.

The first sealing means may include a groove in an inside surface of the housing which receives and engages with opposite sides of the flange. The groove may have an angled portion that is angled towards the second sealing means in the vicinity of the corner edge to engage with at least a portion of the first face of the second sheet of air filtration material.

The housing inner wall may then extend into the groove, the inner wall forming an outer wall of the groove for the flange relative to the particulate filtering portion. The inner wall may then have an angled portion that is angled towards the second sealing means in the vicinity of the corner edge to engage with at least a portion of the first face of the second sheet of air filtration material.

The second sealing means may include at least one projection which extends from an inside surface of the housing and which engages between adjacent folds of the pleated particulate filtration portion. The third sealing means may then be provided at least partly by the compression of air filtration material between the angled portion of the groove and this projection. Alternatively, or additionally, the third sealing means may be provided at least partly by the compression of the air filtration material between the angled portion of the housing inner wall and this projection.

The second sheet of air filtration material may project beyond the pleated side to provide a second flange that extends in a direction opposite to the first flange from a folded side opposite to that from which the first flange extends. The second flange and the first flange then each make a particulate seal with a corresponding feature of the housing to provide the first sealing means.

The housing may include a seam by which upstream and downstream portions of the housing are joined together or separated, the housing including on an inner surface of one portion a first feature for engaging with the first flange and on an inner surface of the other portion a second feature for engaging with the second flange, in order to provide the first sealing means on both sides of the housing seam.

When the second sheet of air filtration material is compressible, and the first and second flanges are substantially co-planar, the first and second feature may serve in use to compress the second sheet of air filtration material.

The first feature may be the groove mentioned above, in which case, the second feature may be a ledge inside the housing. The groove then correctly locates the air filter, which is then compressed along the side sealing portions as the housing is closed and the ledge comes into contact with the second flange.

According to a second aspect of the invention, there is provided an air filter for an air filtration system, when the air filtration system is according to the first aspect of the invention, the air filter having:
a particulate filtration portion for filtering particulates from said inlet air flow, said filtration portion being made from a first sheet of air filtration material folded into a pleated volume, said pleated volume being bounded by a plurality of sides including a pair of opposite folded sides through which said air flow passes, at least one pleated side that extends between said folded sides and at least one end side an end of said series of pleats; and
a side sealing portion along said pleated side, said sealing portion being made from a second sheet of air filtration material, said sheet covering said pleated side and projecting beyond said pleated side to provide a first flange that extends upright from a folded side along a corresponding side edge;
wherein said flange projects upright from said folded side a distance greater than twice the thickness of the second sheet of air filtration material.

According to a third aspect of the invention, there is provided an air filter for an air filtration system, when the air filtration system is according to the first aspect of the invention, the air filter having:
a particulate filtration portion for filtering particulates from said inlet air flow, said filtration portion being made from a first sheet of air filtration material folded into a pleated volume, said pleated volume being bounded by a plurality of sides including a pair of opposite folded sides through which said air flow passes, at least one pleated side that extends between said folded sides and at least one end side an end of said series of pleats; and
a side sealing portion along said pleated side, said sealing portion being made from a second sheet of air filtration material, said sheet covering said pleated side and projecting beyond said pleated side to provide a first flange that extends upright from a folded side along a corresponding side edge;
wherein said flange projects upright from said folded side a distance greater than 10% of the distance between said a pair of opposite folded sides.

When the second sheet of air filtration material projects beyond the pleated side to provide a second flange that extends in a direction opposite to the first flange from a folded side opposite to that from which the first flange extends, the projection of the second flange is preferably less than that of the first flange.

Favorable results have been obtained where this projection of the second flange is no more than half the projection of the first flange.

The first and second sheets of air filtration material are typically of the same type of filtration material, with these first and second sheets being bonded together along a substantially continuous pleated edge over the pleated side.

The air filter may then be formed substantially entirely of filtration material, which is most conveniently a non-woven filter material. In another embodiment of the invention, the side sealing portion is bonded to the particulate filtration portion by means of an adhesive. To form a complete seal, the adhesive preferably follows the zigzag contact line between the exposed edges of pleats of the pleated side of the air filtration material and a substantially planar sheet forming the side sealing portion.

### BRIEF DESCRIPTION OF THE DRAWINGS

The invention will now be further described, by way of example, and with reference to the accompanying drawings, in which:

FIG. 1 is a perspective view of air filter according to a preferred embodiment of the invention, having a rectangular form with a pair of opposite side panels which project upwards above a series of pleats having folds that extend between the side panels;

FIG. 2 is a top view of the air filter of FIG. 1;

FIG. 3 is a cross-section through the air filter, taken along line III-III of FIG. 2;

FIGS. 4, 5 and 6 are, respectively, side and bottom views of the air filter of FIG. 2;

FIG. 7 is a perspective view of a housing, which when used to hold the air filter of FIG. 1, forms an air filtration system according to a preferred embodiment of the invention, the housing having a base portion with an air inlet to supply unfiltered air to a dirty side of the air filter and a lid portion with an air outlet for providing filtered air from a clean side of the air filter;

FIG. 8 is a view from below showing the inside of the lid portion of the air filter housing of FIG. 7;

FIG. 9 is a cross-section of the housing lid portion taken along line IX-IX of FIG. 8, showing how the air filter side panels are compressed firstly between the housing base and lid portions, and secondly by lateral compression of the side panel upward projections within a V-groove formed in the housing lid portion; FIGS. 10 and 11 are cross-sections of the housing lid portion taken along, respectively, lines X-X and XI-XI of FIG. 8 showing how the location of the V-groove shifts laterally inwards in the vicinity of the corners of the air filter in order to improve the seal at these locations; and

FIGS. 12 and 13 show how interlaced inserts are provided to make a seal extending in opposite direction upwards and downwards from, respectively the air filter housing base and lid portions.

### DETAILED DESCRIPTION

The following description is merely exemplary in nature and is not intended to limit the present disclosure, application, or uses. It should also be understood that throughout the drawings, corresponding reference numerals indicate like or corresponding parts and features.

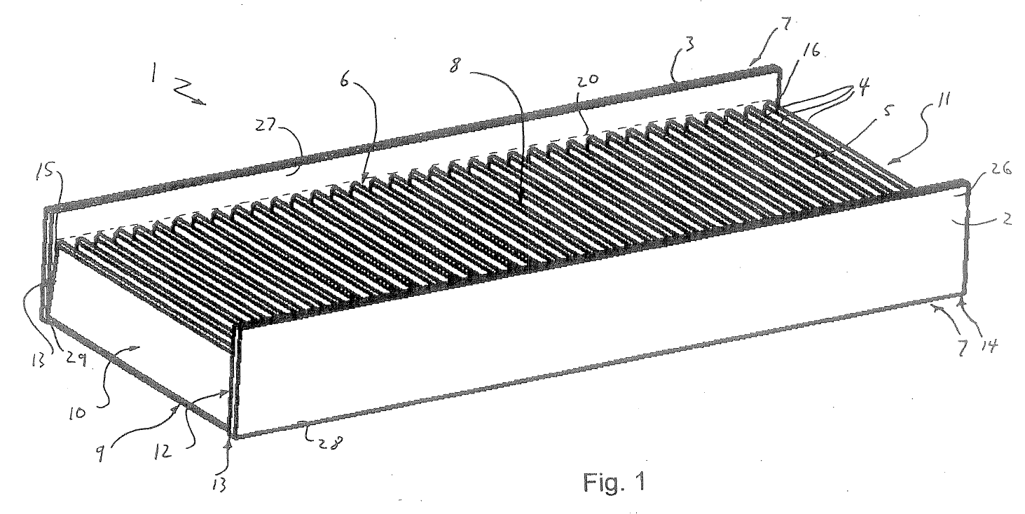

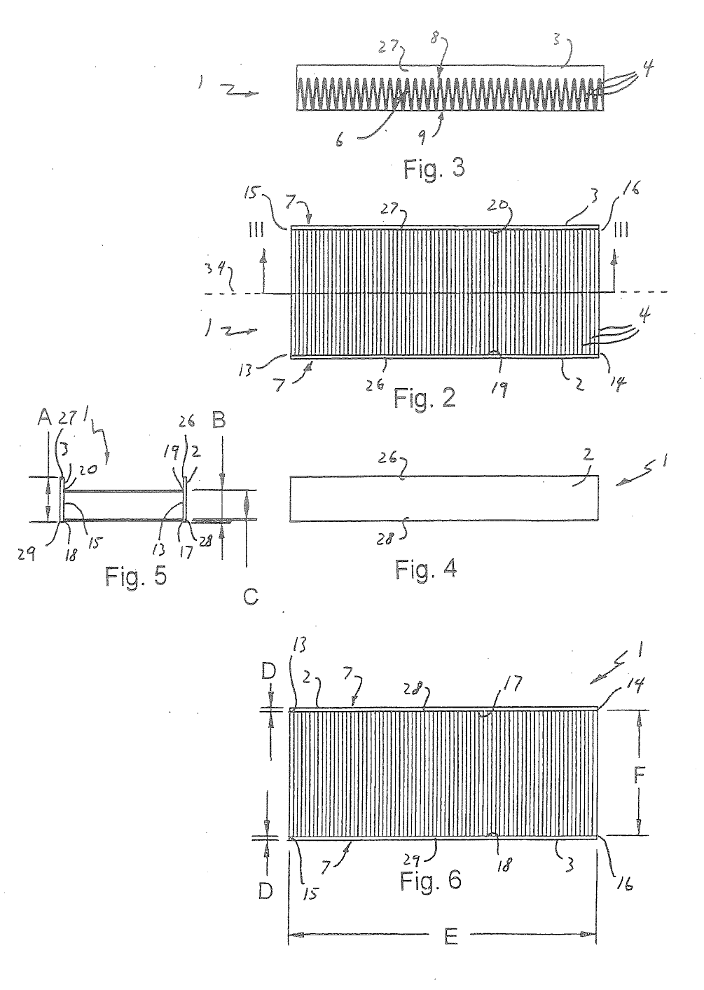

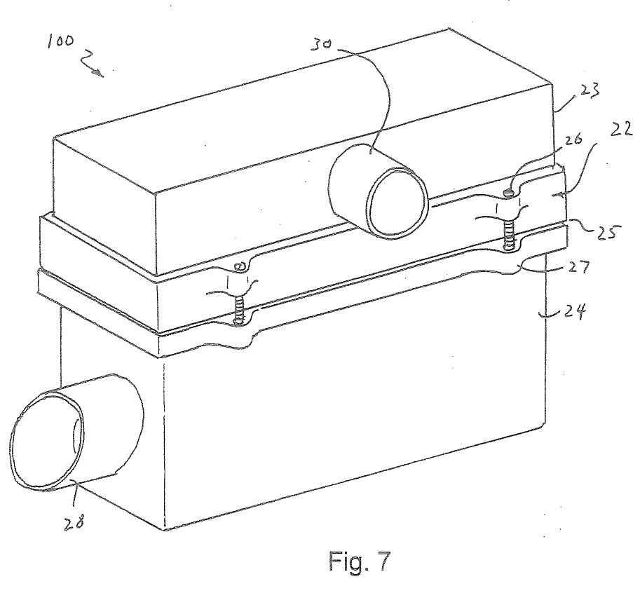

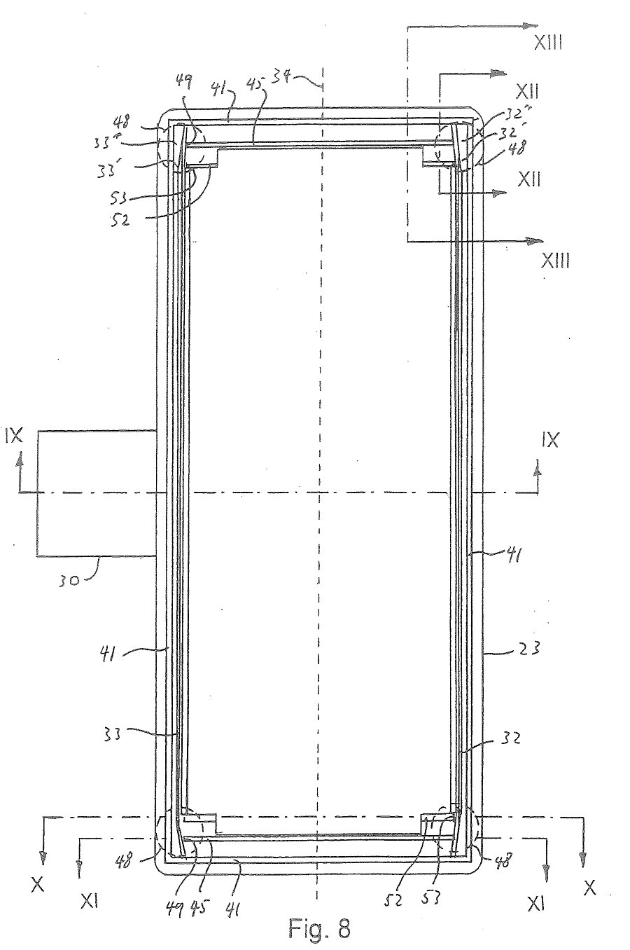

FIGS. 1 to 6 show various views of an air filter 1 according to an embodiment of the invention. The air filter has a rectangular form with a pair of opposite side panels 2, 3 which project upwards above a series of pleats 4 having folds 6 that extend between the side panels 2, 3 and which in use filter particulates from an air flow channeled through the pleats between the side panels 2, 3.

In functional terms, therefore, the air filter has a particulate filtration portion 5 formed by the series of pleats 4, and a side sealing portion 7 formed by the side panels 2, 3. The particulate filtration portion 5 is made from a first sheet of non-woven and compressible air filtration material that is folded into a pleated volume 6. The pleated volume is bounded by a number of sides including a pair of opposite folded sides 8, 9 through which the air flow passes, a pair of opposite pleated sides that extend between the folded sides 8, 9 and a pair of opposite end sides 10, 11 at opposite ends of the series of pleats 4. The opposite pleated sides are not directly visible in the drawings, and both of these are covered by the side panels 2, 3, but the location of these sides are indicated in the drawings by arrows 12, 13.

The pleated and end sides meet along four corner edges 13, 14, 15, 16 of the pleated volume 6. The pleated sides 12, 13 meet each of the folded sides 8, 9 along upstream side edges 17, 18 and downstream side edges 19, 20 (one of which 20 is indicated by a dashed line in FIG. 1) that extend along the series of pleats 4.

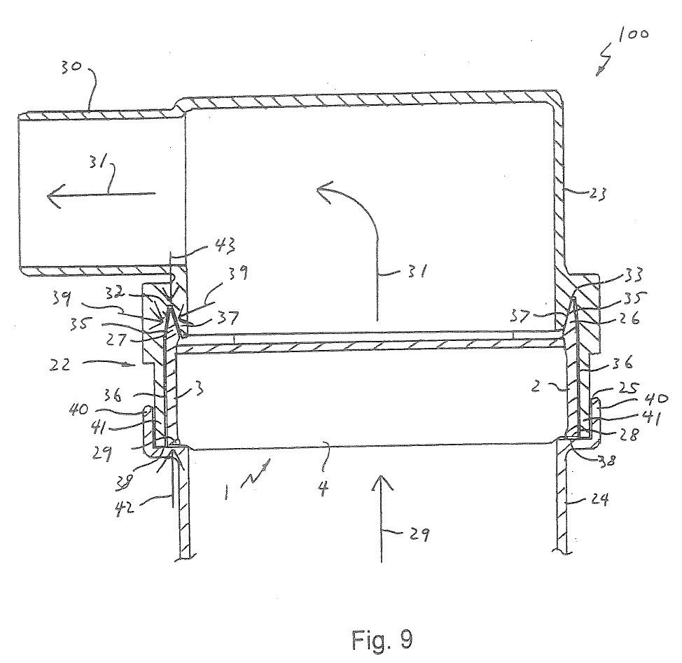

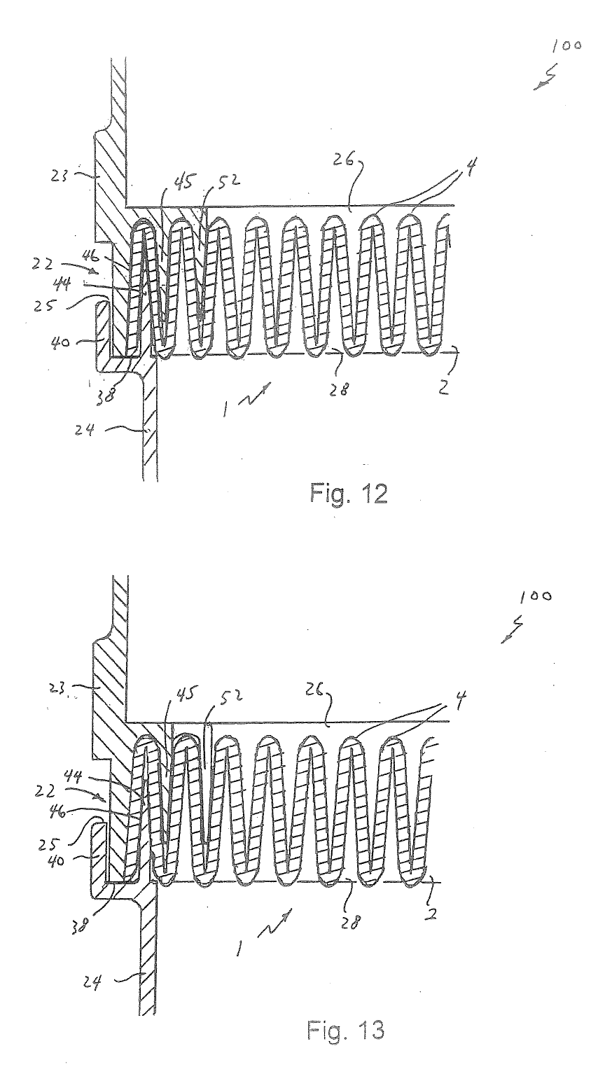

Reference is now made also to FIGS. 7-13 which show various views of an embodiment of air filtration system 100. The system comprises an air filter housing 22, inside of which the air filter 1 is removably held. The housing 22 is in two halves, having a downstream portion 23 and a upstream portion 24, joined together along a seam 25 by means of screws 26 at four mounting points 27. The filter portions 23, 24 can be separated in order to change the air filter 1.

The housing has an air inlet 28 for providing an unfiltered inlet air flow 29 to the air filter 1 and an air outlet 30 for receiving a filtered outlet air flow 31 from the air filter 1.

When mounted inside the housing 22, the side panels 2, 3 function as a side sealing portion 7 for providing a particulate seal within the housing 22 along the pleated sides 12, 13. The sealing portion 7 is made from two sheets of air filtration material which cover the pleated sides 12, 13 and which project beyond the pleated sides 12, 13 in both the upstream and downstream directions to provide a pair of parallel first flanges 26, 27 that extend upright from the downstream folded side 8 all along the corresponding side edges 19, 20, and also to provide a pair of parallel second flanges 28, 29 that extend upright from the upstream folded side 9 all along the corresponding side edges 21, 22. The first flanges 26, 27 therefore extend in an opposite direction from the second flanges 28, 29.

Various compressive interactions between the housing 22 and the air filter 1 provide a particulate seal around the periphery of the air filter 1 to substantially prevent particulates from passing from the upstream to the downstream portions 23, 24 of the housing 22 without passing through the air filter. The arrangement also substantially prevents particulates which might enter the housing through the housing seam 25 from entering the downstream portion 23 of the housing without first passing through the side panels 2, 3.

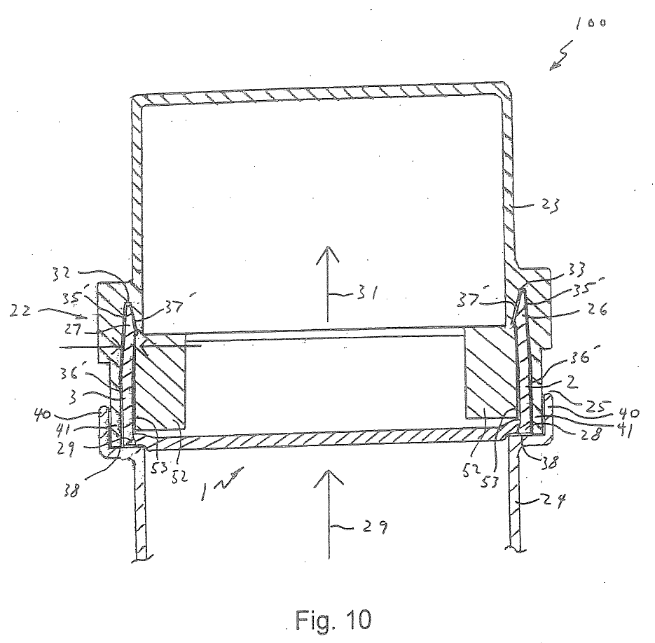

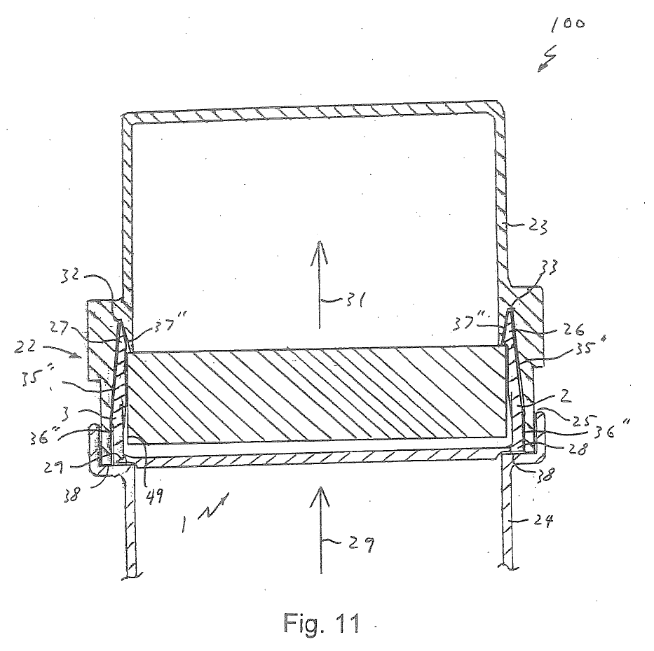

As shown in FIGS. 8 and 9, a pair of grooves 32, 33 extends parallel with and on opposite sides of a longitudinal central axis 34 of the housing 22 and of the air filter 1. The grooves 32, 33 each have a V-profile with a groove wall 35 on the outermost side relative to the axis 34 tapering outwards into a side wall 36 within the housing downstream portion 23. An innermost side wall 37 of each groove 32, 33 tapers outwards to a lip 38 which, when each of the first flanges 27, 28 is fully seated in the corresponding groove 32, 33, reaches almost to the corresponding edge 19, 20 of the downstream folded surface 8 of the filtration portion 7.

When a filter 1 is fitted to the housing, the pair of first flanges 26, 27 is first seated in the pair of grooves 32, 33, during which the flanges are compressed inwardly by the V-groove profile, as indicated in FIG. 9 by arrows 39.

The upstream housing portion 24 has a ledge 38 that projects inwardly from an external lip 40. The ledge extends fully around the housing upstream portion 24 and the lip 40 extends fully around the housing upstream portion 24 and receives a lower rim 41 of the housing portion 23 in a close sliding fit to provide a primary particulate seal around the housing seam 25. The rim 41 is pulled down onto the ledge 38 when the screws 26 are tightened. At the same time, the pair of second flanges 28, 29 are compressed upwardly by the ledge 38, with a consequent downward compression on the first flanges within the groove, as indicated in FIG. 9 by arrows 42 and 43. This ensures that the inward compression 39 is maintained.

The inward compression 39 on the first flanges 26, 27 and upwards compression on the second flanges 28, 29 provide a pair of longitudinal seals that extend the length of the filter 1 on opposite sides of the longitudinal axis 34, and also on both sides of the seam 25 along these sides. In the context of the present invention, this provides a first seal along the side panels 2, 3 of the air filter 1.

A second seal is provided along the end sides 10, 11 of the air filtration volume 6 by means of a pair of interlaced projections or inserts 44, 45 which slot in between adjacent pleats 4. One insert 44 is provided on the upstream housing portion 24 and projects upwardly from the ledge 38 opposite the end sides 10, 11 of the filter 1, and the other insert 45 is provided on the downstream housing portion 23 and projects downwards so that one pleat is held between the two projections 44, 45. An end wall 46 of the housing downstream portion 23 projects downwards so that another pleat is held between the end wall and the upwards projection 44. This provides a seal along the end sides 10, 11 of series of pleats 4.

A third seal is provided between the first and second seal in the vicinity of the air filter corners 13, 14, 15, 16 as indicated by the dashed circled lines 48 in FIG. 8. This is provided by a compressive interaction of the air filter side panels 2, 3, including the first and second flanges 26, 27, 28, 29 between end portions 32′, 32″ 33′, 33″ of the groove and the interlaced projections 44, 45. In the corner regions 48, the grooves 32′, 32″, 33′, 33″ are bent inwardly towards the longitudinal axis and towards an end surface 49 of the downwards projection 45. Each end surface 49 extends parallel with the plane of the corresponding side panel 2, 3, while the groove 32″, 33″ is angled in towards this surface 49 so that the side portions are compressed along lines opposite each of the end surfaces.

Optionally, the upwards projection may also have a similar end surface (not shown) to further compress the side panels 2, 3 in a similar manner.

As shown in the drawing, to ensure a good particulate seal in the corner regions 48, each corner region has a second downward projection 52 provided in the housing downstream portion 23 parallel with the first downward projection 45. The second downward projection engages inside a pleat next to that in which the first projection 45 is seated. This is not to add to the second sealing means, but so that an end surface 53 of the second projection can provide a second line of compression in the corresponding side panel 2, 3 where the groove 32′, 33′ is angled in towards this surface 53.

With reference to FIGS. 5 and 6, the dimensions of the air filter are as follows:

| | | |
|---|---|---|
| Height of side panels: | A | 35.5 ± 0.5 mm |
| Height of pleated air filter to base of side panels: | B | 25.5 ± 0.5 mm |
| Height of pleats: | C | 24.5 ± 0.5 mm |
| Width of side panels: | D | 3.0 ± 1 mm |
| Length of pleats: | E | 251.6 ± 2 mm |
| Width of pleats: | F | 99.0 ± 1 mm |

In summary, the first sealing means engages the first flanges 26, 27 along the length of a corresponding side edge 19, 20 to provide a first particulate seal between the housing 22 and the air filter 1. The second sealing means engages with at least one pleat 4 at or near the end of the series of pleats 4 along a corresponding end side 10, 11 to provide a second particulate seal between the housing 22 and the air filter 1. The third sealing means engages the side panels 2, 3 along corner edges 14, 14, 15, 16 to provide a third particulate seal between the housing 22 and the air filter 1, this third particulate seal extending between the first and second particulate seals.

Because each of the seals is made progressively as the air filter is inserted and the housing halves are brought together, the seal is automatically and securely made once the housing halves have been closed. The air filter can then at a later time be replaced.

Because the air filter is made entirely from air filtration material plus adhesive to hold the air filtration portion and side sealing portions together, the air filter can be made using low cost manufacturing techniques.

The efficiency of the air filtration particulate seals can be made to be in excess of 99%, which is more than adequate for use within the air inlet to an internal combustion engine.

The invention therefore provides a convenient air filter and air filtration system for an internal combustion engine.

The invention is not limited to the embodiments described and represented in the attached drawings. Modifications are still possible, in particular with regard to the configuration of the various elements or substituting equivalent techniques without departing as such from the scope of protection of the invention.

What is claimed is:

1. An air filtration system for an internal combustion engine comprising:
an air filter housing having an air inlet for receiving an unfiltered inlet air flow and an air outlet for receiving a filtered outlet air flow; and
an air filter removably held within the housing, wherein the air filter further comprises:
a particulate filtration portion for filtering particulates from the inlet air flow, the filtration portion produced from a first sheet of air filtration material folded into a pleated volume, the pleated volume bounded by a plurality of sides including a pair of opposite folded sides through which the air flow passes, at least one pleated side that extends between the folded sides, and at least one end side at an end of the pleated volume, the pleated side and the end side meeting along at least one corner edge of the pleated volume and the pleated side meeting each of the folded sides along side edges that extend along the pleated volume;
a side sealing portion for forming a particulate seal within the housing along the pleated side, the sealing portion produced from a second sheet of air filtration material, the sealing portion covering the pleated side and projecting beyond the pleated side to provide a first flange, and including spaced apart corner edges;
wherein the housing includes a first seal that engages the flange to provide a first particulate seal between the housing and the air filter, a second seal that engages the end side to provide a second particulate seal between the housing and the air filter, and a third seal that engages the second sheet of air filtration material along the corner edges to provide a third particulate seal between the housing and the air filter, the third particulate seal extending between the first and second particulate seals.

2. An air filtration system according to claim 1, wherein the side sealing portion is substantially planar.

3. An air filtration system according to claim 1, wherein the first seal includes a groove formed in an inside surface of the housing which receives and engages the flange.

4. An air filtration system according to claim 1, wherein the second sheet of air filtration material has a first face which faces outwards from the air filter and a second face which faces inwards towards the particulate filtration portion, the third seal arranged to engage at least a portion of both of the first face and the second face of the third particulate seal.

5. An air filtration system according to claim 4, wherein the third seal is formed by an interaction between the first seal and the second seal adjacent the corner edges.

6. An air filtration system according to claim 5, wherein the second sheet of air filtration material is compressible.

7. An air filtration system according to claim 4, wherein the first seal includes a groove formed in an inside surface of the housing which receives and engages with the flange, the groove having an angled portion that is angled towards the second seal in the vicinity of the corner edges to engage at least a portion of the first face.

8. An air filtration system according to claim 7, wherein the housing has an inner wall which extends into the groove, the inner wall forming an outer wall of the groove for the flange relative to the particulate filtration portion, at least a portion of the inner wall forming the angled portion.

9. An air filtration system according to claim 1, wherein the second seal includes at least one projection which extends from an inside surface of the housing and engages between adjacent folds of the pleated volume of the particulate filtration portion.

10. An air filtration system according to claim 9, wherein the second sheet of air filtration material is compressible and the third seal is formed at least partly by compression of the air filtration material between the angled portion of the groove and the projection.

11. An air filtration system according to claim 8, wherein the second seal includes at least one projection which extends from an inside surface of the housing and engages between adjacent folds of the pleated volume of the particulate filtration portion, and wherein the second sheet of air filtration material is compressible and the third seal is formed at least partly by compression of the air filtration material between the angled portion and the projection.

12. An air filtration system according to claim 1, wherein the second sheet of air filtration material projects beyond the pleated side to provide a second flange that extends in a direction opposite to the first flange from a pleated side opposite to that from which the first flange extends, the second flange and the first flange each making a particulate seal with a corresponding feature of the housing to form the first seal.

13. An air filtration system according to claim 12, wherein the housing includes a seam by which an upstream portion and a downstream portion of the housing are separably joined, the housing including on an inner surface of one of the upstream portion and the downstream portion a first feature for engaging with the first flange and on an inner surface of the other of the upstream portion and the downstream portion a second feature for engaging with the second flange to provide the first seal on both sides of the seam.

14. An air filtration system according to claim 13, wherein the second sheet of air filtration material is compressible, and the first flange and the second flange are substantially co-planar, the first feature and the second feature compressing the second sheet of air filtration material.

15. An air filter comprising:
a particulate filtration portion for filtering particulates from an inlet air flow, the filtration portion produced from a first sheet of air filtration material folded into a pleated volume, the pleated volume bounded by a plurality of sides including a pair of opposite folded sides through which the air flow passes, at least one pleated side that extends between the folded sides, and at least one end side at an end of the pleated volume, the pleated side and the end side meeting along at least one corner edge of the pleated volume and the pleated side meeting each of the folded sides along side edges that extend along the pleated volume; and
a side sealing portion for forming a particulate seal with a housing along the pleated side, the sealing portion produced from a second sheet of air filtration material, the sealing portion covering the pleated side and projecting beyond the pleated side to provide a first flange, and including spaced apart corner edges.

16. The air filter according to claim 15, wherein the flange projects upwardly from the pleated side a distance greater than twice a thickness of the second sheet of air filtration material.

17. The air filter according to claim 16, wherein the second sheet of air filtration material projects beyond the pleated side to provide a second flange that extends in a direction opposite to the first flange from a pleated side opposite to that from which the first flange extends, the projection of the second flange being less than that of the first flange.

18. The air filter according to claim 17, wherein the projection of the second flange is no more than half the projection of the first flange.

19. The air filter according to claim 15, wherein the first sheet and the second sheet of air filtration material are the same type of filtration material, the first sheet and the second sheet bonded together along a continuous pleated edge over the pleated side.
